(19) United States
(12) Patent Application Publication
(10) Pub. No.: US 2023/0026044 A1
(43) Pub. Date: Jan. 26, 2023

(54) METHOD AND ARRANGEMENT FOR REDUCING IMPURITIES FROM A ROASTED MOLYBDENUM CONCENTRATE

(71) Applicant: Molymet Belgium NV, Gent (BE)

(72) Inventors: Guido Provoost, Gent (BE); David Langendries, Gent (BE)

(21) Appl. No.: 17/785,018

(22) PCT Filed: Dec. 17, 2020
(86) PCT No.: PCT/EP2020/086667

§ 371 Date: Jun. 13, 2022

(30) Foreign Application Priority Data
Dec. 17, 2019 (EP) 19217039.7

(51) Int. Cl. C22B 3/00; C01G 39/00; C22B 34/34

(52) U.S. Cl. CPC C22B 3/00; C01G 39/003; C22B 34/34

(57) ABSTRACT

The invention provides a method for reducing impurities from roasted molybdenum concentrate (RMC), comprising: performing a first treatment in a first reactor, on a portion of the RMC forming a first treated suspension, the first treatment comprises adding the portion of the RMC to a water-solution, wherein the first treated suspension has a temperature from 10° C. to 100° C. and a first pH value of from 2.1 to 5.0; performing a second treatment in a second reactor on a portion of the first treated suspension, the second treatment comprises adding the portion of the first treated suspension to an acid solution to form the second treated suspension, wherein the portion of the first treated suspension has a temperature <70° C., and wherein the second treated suspension has a second pH value between 1.5 and the first pH value; and separating a portion of the second treated suspension from the reactors.

### TECHNICAL FIELD

The present invention relates to a method for reducing impurities from a roasted molybdenum concentrate (RMC) and compositions obtained thereof, and to an RMC treatment arrangement adapted for performing the method.

### BACKGROUND ART

In nature, molybdenum mainly occurs in the form of molybdenite (MoS₂), an ore of molybdenum. For the many applications in which molybdenum is used, molybdenite is oxidized to molybdenum oxide, which is then utilized mainly for the production of alloys containing molybdenum, and catalysts. The oxidation of molybdenite (MoS₂) to molybdenum oxide can be carried out according to two methods. The first and most common method of oxidation is by roasting the molybdenum ores in a roasting furnace in the presence of air. It is well known that ores or concentrates, preferably molybdenum (MoS₂) concentrates, can be processed into roasted molybdenum concentrate by roasting said molybdenum-containing ores or concentrates. A second option with which molybdenum oxide of higher purity is obtained is to oxidize molybdenite via a wet chemical route. This involves working in an acid environment and the conditions are adjusted so that molybdenum dissolves the least, but the impurities are dissolved to a higher extent. Via the wet chemical route, molybdenite is oxidized in an autoclave under pressure in a highly concentrated oxygen (O₂) atmosphere and/or with nitric acid (HNO₃) as an oxidizer. These reactions also take place in the presence of sulphuric acid (H₂SO₄), which is optionally added but also formed during the oxidation of molybdenite. Disadvantages of the wet chemical route as method of oxidation of ores of molybdenum are its high energy consumption and high costs, as concentrated oxygen is much more expensive than air. Moreover, working with an autoclave is very delicate, as the molybdenite used must be de-oiled to prevent explosion in the autoclave and abrasive gangue must be limited to prevent damage to the autoclave.

Molybdenite ore still contains a variety of impurities such as, but not limited to, arsenic, phosphorus, iron, copper and potassium. These impurities can also be found to a greater or lesser extent in the molybdenum oxide produced, depending on the oxidation method used.

Specific applications require molybdenum oxide of a purity which is higher than the one obtainable via only roasting or wet chemical oxidation. Molybdenum oxide of higher purity can be obtained via sublimation, or via a wet chemical route wherein molybdenum oxide is firstly dissolved in ammonia to produce an ammonium molybdenum salt, such as, but not limited to ammonium dimolybdate, ammonium tetramolybdate or compositions thereof. Highly pure molybdenum oxide can be obtained by decomposing by heating the ammonium molybdenum salt.

In the conversion of RMC to an ammonium molybdenum salt, the presence of potassium is a critical factor since the potassium concentration has a significant influence on the properties of the final product. Potassium cannot be selectively removed from the solution of the ammonium molybdenum salt, and the concentration of potassium in the molybdenum oxide of higher purity obtained via the decomposition of an ammonium molybdenum salt can only be kept low by working with RMC already having a low potassium content. It is therefore important to remove from the RMC those impurities which can be dissolved in ammonia, such as, but not limiting to, potassium, because they cannot be selectively removed from the solution of ammonium molybdenum salt.

U.S. Pat. No. 3,848,049 describes the leach of RMC with warm water, which temperature of the warm water is between 10 to 100° C. Alternatively, instead of using warm water, the step of leaching uses a solution of a mineral acid in hot water, preferably nitric acid, which concentration of mineral acid can be from 1% to 10%, preferably from 1% to 5%. The use of nitric acid leads to nitrates ending up in the leaching solution with the other impurities. The use of nitric acid is to be avoided for environmental reasons, as nitrates are pollutants which have to be removed from the wastewater. Therefore, a drawback of U.S. Pat. No. 3,848,049 is that the use of nitric acid as mineral acid poses threats to the environment and is more expensive than other mineral acids. Moreover, the leaching method described in U.S. Pat. No. 3,848,049 does not provide for a method of purification by leaching in which both the concentration of potassium and other metal cations is drastically reduced.

U.S. Pat. No. 5,271,911 describes a method for removing potassium from molybdenum trioxide by acid leach treatment. The leaching solution consists of mineral acid, and the ammonium salt of the mineral acid. The preferred mineral acid used is nitric acid. A drawback of the leaching method described in U.S. Pat. No. 5,271,911 is that it does not provide for a method of purification by leaching in which the concentration of potassium and other metal cations are drastically reduced. Moreover, U.S. Pat. No. 5,271,911 describes the use of solutions of nitric acid, that is environmentally unfriendly, due to nitrates possibly ending up in the wastewater, and the use of ammonium nitrate, which is also environmentally problematic if becoming part of the wastewater as nitrates, and additionally, the ammonium nitrate is potentially explosive when dry, requiring extra safety for the production process.

U.S. Pat. No. 3,932,580 describes the step of firstly mixing RMC with sulphuric acid before being subject to a heat treatment (RMC is firstly baked from 150 to 250° C. and the roasted from 300 to 600° C.). The heat treatment requires firstly, which is important for improving the handling of the RMC. After the heat treatment, and after a subsequent grinding step, the obtained product is leached with warm water. The leaching with warm water is performed at a temperature from 50 to 85° C., from 1 to 3 hours. A drawback of the method of leaching according to U.S. Pat. No. 3,932,580 is that the method is energy and labour intensive, as steps heat treatment and pelletization are required.

U.S. Pat. No. 4,643,884 describes a method for removing potassium from relatively impure molybdenum trioxide. The molybdenum trioxide is contacted twice with an acid leach solution consisting essentially of nitric acid and ammonium nitrate at a temperature of at least 50° C. Between every leaching steps, the molybdenum trioxide is separated from the leach. According to the invention, the majority of the potassium is leached out by the acid leach steps. Optionally, between the first acid leaching step and the second acid leaching step, the molybdenum trioxide is leached with water, to remove any residual impurity. A drawback of the method as described in U.S. Pat. No. 4,643,884 is that the removal of potassium is achieved by using a solution containing nitric acid and ammonium nitrate, which are environmentally problematic if becoming part of the wastewater as nitrates, and additionally, the ammonium nitrate is potentially explosive when dry, requiring extra safety for the production process. Another drawback of the method described in U.S. Pat. No. 4,643,884 is that several leaching steps are required, so that that is globally not efficient on an industrial scale, and several steps of separation are required as well, to separate the molybdenum trioxide from the leach, resulting in a more energy and labour intensive method for removing potassium.

Therefore, there is need for an improved method for reducing the concentration of impurities from a roasted molybdenum concentrate (RMC), which method is less labour intense, less expensive and allows for an efficient removal of the impurities, and is safer for the environment and the operators carrying out the method.

### SUMMARY OF INVENTION

The present invention aims in particular to overcome these disadvantages of the prior art. More in particular, an object of the present invention is to provide for a method for reducing impurities from a roasted molybdenum concentrate (RMC). The method is less labour intense, less expensive, which allows for an efficient removal of the impurities, and is safer for the environment and the operators carrying out the method. The method according to the present invention comprises the steps: a. performing a first treatment in a first reactor or a first series of reactors, on at least a portion of the RMC during a first treatment reaction time to form a first treated suspension, the first treatment comprises a step of adding the at least a portion of the RMC to a water-solution or an aqueous solution, wherein the first treated suspension has a temperature from 10° C. to 100° C. and a first pH value of at least 2.1 and preferably to at most 5.0, preferably to at most 4.0, preferably to at most 3.0, preferably to at most 2.8; b. performing a second treatment in a second reactor or a second series of reactors, on at least a portion of the first treated suspension during a second treatment reaction time, preferably wherein the portion of the first treated suspension comprises RMC solids from the first treated suspension, wherein the second treatment comprises a step of adding the at least a portion of the first treated suspension to an acid solution to form the second treated suspension, wherein the at least a portion of the first treated suspension has a temperature less than 70° C., and wherein the second treated suspension has a second pH value between 1.5 and the first pH value; and c. separating at least a portion of the second treated suspension from the second reactor or a second series of reactors after the second treatment reaction time. An advantage of the method for reducing impurities, in particular a concentration of, from a roasted molybdenum concentrate according to the present invention is that impurities can be removed more energy and cost efficient, in a less labour intense way and in a more environmental way, as the use of nitric acid can be avoided. Surprisingly, it was found that if the suspension comprising the acid compound is added at a temperature of less than about 70° C. and a pH between about 1.5 and about 2.3, the removal of potassium and copper is more efficient than if temperature higher than 70° C. and a pH outside the abovementioned range is used. The method according to the invention may be carried out without the need to pulverise the RMC. The method according to the invention may be carried without any purification of the RMC. The method according to the invention may be carried out on RMC with a high copper content, preferably as high as 4.0% by weight, preferably as high as 3.5% by weight, preferably as high as 3.0% by weight, preferably as high as 2.0% by weight, preferably as high as 1.5% by weight, preferably as high as 1.0% by weight, preferably as high as 0.5% by weight, the % by weight being expressed to the total weight of RMC.

According to an embodiment of the present invention, the acid solution comprises either hydrochloric acid or sulphuric acid, or combinations thereof, preferably sulphuric acid. An advantage of this embodiment is that sulphuric acid and hydrochloric acid are environmentally safer than other acids, such as nitric acid. Hydrochloric acid can be utilized in the context of the present invention instead of sulphuric acid, but the use of sulphuric acid and solution of sulphuric acid are preferred. An advantage of using sulphuric acid rather than hydrochloric acid, is that sulphates are easier to remove from the waste water than chlorides, which makes it the better choice environmentally speaking. In addition the corrosion of the industrial equipment used to carry out the method is minimal with respect to sulphuric acid. Moreover, the leaching efficiency demonstrated by utilizing sulphuric acid is higher than when hydrochloric acid is used.

According to a preferred embodiment of the present invention, the method comprises, prior to the step of adding the at least a portion of the first treated suspension to an acid solution to form the second treated suspension, a step of adding a predetermined amount of water to the first reactor, the first series of reactors, the second reactor, or the second series of reactors such that the at least a portion of the first treated suspension has a temperature less than 70° C. In addition to the advantages of the previous embodiments, a further advantage of the present embodiment is that the temperature of the at least portion of the first treated suspension may be easier and faster decreased to the desired temperature in comparison with cooling via natural convection. In addition, the leach efficiency of potassium may not be impacted and the leach efficiency of other impurities is improved.

According to a preferred embodiment of the present invention, at step a., the first treated suspension has a temperature of at least 60° C., preferably at least 75° C. In addition to the advantages of the previous embodiments, a further advantage of the present embodiment is that the impurities of potassium can be solubilized faster than at temperatures lower than 60° C.

According to an embodiment of the present invention, the reactor in step a. and the reactor in step b. are the same.

According to an embodiment of the present invention, the reactor, the first series of reactors and the second series of reactors are the same. An advantage of the present embodiment is that the method according to the present invention can be performed in a smaller scale and requires less equipment, therefore allowing for a method that is more cost efficient and less labour intense.

According to an embodiment of the present invention, a method is provided comprising a step of filtering the at least a portion of the first treated suspension from the first treated suspension prior to performing the second treatment, wherein the at least a portion of the first treated suspension which is passed on to the second treatment is the RMC cake. In addition to the advantages of the previous embodiments, a further advantage of the present embodiment is that by removing the filtrate which contains the dissolved K, the danger of precipitating the K at lower pH during the second treatment is removed.

According to a preferred embodiment of the invention, a method is provided further comprising a step of transferring the at least a portion of the first treated suspension from the first reactor or the first series of reactors to at least one subsequent reactor, wherein the at least one subsequent reactor is selected from the group of the first reactor or first series of reactors and the second reactor or second series of reactors. This embodiment allows to apply a continuous process for the treatment and leaching (i.e. removing impurities) of RMC, resulting in a higher leaching efficiency (i.e. more RMC can be treated on a shorter period) in comparison with a batch process wherein the second treatment step may only performed after finalizing the first treatment step. According to the present embodiment of the invention, the reduction of impurities from RMC is more time efficient, as larger amounts of RMC can be continuously treated.

According to a preferred embodiment of the invention, a method is provided wherein the step of transferring is performed through overflow, wherein the first reactor or the first series of reactors and the subsequent reactor are placed in the flow direction of the at least a portion of the first and second treated suspension. In addition to the advantages of the previous embodiments, a further advantage of the present embodiment is that the process of overflow is a natural process that does not require complex control equipment, leading to a cost-efficient method to reducing (a concentration of) impurities from RMC.

In a particular embodiment of the present invention, a method is provided wherein the second treated suspension has a temperature of less than 65° C., preferably less than about 55° C. The inventors surprisingly found that impurities of potassium in the RMC can be better removed than at temperature higher than 65° C. because there is a smaller decrease of efficiency of the potassium removal.

In a preferred embodiment of the present invention, the second treated suspension has a pH value between 1.8 and 2.0, preferably 1.9. In addition to the advantages of the previous embodiments, a further advantage of the present embodiment is that potassium impurities precipitate the least from the suspension, with the leaching efficiency of potassium not substantially decreasing while other impurities are leached out from the RMC.

In a particular embodiment of the present invention, the first treatment reaction time is between approximately 20% to 80%, preferably between approximately 35% to 60%, more preferably around 40% of a total reaction time, wherein the total reaction time being the sum of the first treatment reaction time and the second treatment reaction time. In addition to the advantages of the previous embodiments, a further advantage of the present embodiment is that the leach efficiency of potassium and of copper are higher than when the reaction time is not between approximately 20% to 80%.

In a particular embodiment of the present invention, the second treated suspension has a liquid-to-solid (L/S) ratio in mass between approximately 2.0 and 3.0, preferably around 2.6. In addition to the advantages of the previous embodiments, an advantage of this embodiment is that the removal of impurities of iron and copper is more efficient. An L/S-ratio lower than 2.0 gives a decrease of efficiency of the removal of, among others, iron and copper. Raising the L/S-ratio higher than 3.0 gives no further significant improvement in the efficiency, while having the economic disadvantage of needing larger reactors.

Another aspect of the invention relates to a roasted molybdenum concentrate (RMC) treatment arrangement for reducing the concentration of impurities from the RMC according to any of the previous claims, the arrangement comprising: a first reactor or a first series of reactors adapted for performing a first treatment in a reactor or a first series of reactors, on at least a portion of the RMC during a first treatment reaction time to form a first treated suspension, the first treatment comprises a step of adding the at least a portion of the RMC to a water-solution or an aqueous solution, wherein the first treated suspension has a temperature from 10° C. to 100° C. and first pH value of at least 2.1 and preferably to at most 5.0, preferably to at most 4.0, preferably to at most 3.0, preferably to at most 2.8; a second reactor or a second series of reactors adapted for performing a second treatment in a second reactor, or a second series of reactors on at least a portion of the first treated suspension during a second treatment reaction time, preferably wherein the portion of the first treated suspension comprises RMC solids from the first treated suspension, wherein the second treatment comprises a step of adding the at least a portion of the first treated suspension to an acid solution to form the second treated suspension, wherein the at least a portion of the first treated suspension has a temperature less than 70° C., and wherein the second treated suspension has a second pH value between 1.5 and the first pH value; and a separation means adapted for separating at least a portion of the second treated suspension from the second reactor or the second series of reactors after the second treatment reaction time. An advantage of this embodiment for reducing impurities from a roasted molybdenum concentrate according to the present invention is that impurities can be removed efficiently.

According to a preferred embodiment of the invention, the first and the second series of one or more reactors are the same. An advantage of the present embodiment is that the method according to the present invention can be performed on a smaller scale.

According to a preferred embodiment of the invention, an arrangement is provided further comprising an equipment for transferring at least a portion of the first treated suspension from the first reactor or the first series of reactors to a subsequent reactor, wherein the subsequent reactor is selected from the group consisting of the first reactor or first series of reactors and the second reactor or second series of reactors. An advantage of this embodiment is that the present invention can be performed as a continuous process, making the reduction of impurities from roasted molybdenum concentrate more time efficient, as the method can be performed without interruption. In addition, the process of overflow is a natural process which does not require complex control equipment, leading to a cost-efficient process.

According to a preferred embodiment of the invention, an arrangement is provided wherein the equipment for transferring is an overflow. An advantage of this embodiment is that no pumps are needed for the transfer in this embodiment.

The invention also relates to a treated RMC product obtained by a method according to any of the previous claims, wherein the treated RMC product contains a concentration of less than 0.0864% by weight, preferably less than 0.0240% by weight of potassium, less than 0.24% by weight, preferably less than 0.08% by weight of copper, and more than 50.00% by weight, preferably more than 56.47% weight, preferably more than 58.67% by weight of molybdenum, based on the total weight of treated RMC product. An advantage of the purified roasting molybdenum concentrate obtained according to the method described in the present invention is that it is suitable to be used in specific applications in which the concentration of soluble potassium has to be minimum, without the need for further purification steps.

### BRIEF DESCRIPTION OF THE FIGURES

In order to better demonstrate the characteristics of the invention, there is described below, purely as an example and without being in any way whatsoever limiting, at least one preferred embodiment of a method for reducing impurities from RMC with reference to the accompanying figures, in which:

FIG. 1, abbreviated as “FIG. 1”, is a bar chart illustrating the leach efficiency of the method for reducing the concentration of impurities from RMC according to the present invention, with Example A being the case in which no acid is used, Example B being the case in which only hydrochloric acid is used, and Example C being the case according to the present invention, wherein a first treatment with water is performed and then a second treatment with sulphuric acid is performed;

FIG. 2, abbreviated as “FIG. 2”, illustrates the leach efficiency of impurities with respect to the time of addition of the acid to at least a portion of the first treated suspension, which time is expressed as percentage of the total reaction time, with example A being wherein no acid is used during the method in accordance with the present invention;

FIG. 3, abbreviated as “FIG. 3”, illustrates the changes in leach efficiency of impurities with respect to the temperature of the second treated suspension after the addition the acid compound;

FIG. 4, abbreviated as “FIG. 4”, illustrates the steps of the method for reducing the concentration of impurities from RMC according to the present invention; and

FIG. 5, abbreviated as “FIG. 5”, illustrates a leaching apparatus to perform the method according to the present invention via a continuous process.

### DETAILED DESCRIPTION

The following detailed description aims to describe preferred embodiments of the invention and is not intended to be a limited representation of the only embodiments in which the invention can occur or be applied. The description seeks to be clear about the functionalities and steps necessary to construct and operate the invention. It should be understood that the same or equivalent functionalities and components can be obtained by other embodiments and that these are also intended to fall within the scope of protection of the invention. The drawings described are merely schematic and not limiting.

Furthermore, the terms first, second, third fourth and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

The Applicant's disclosure is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

When in at least one embodiment according to the present invention reference is made to the term “roasted molybdenum concentrate” or “RMC”, reference is made to matter as described by the “REACH Molybdenum Consortium” (RMC Sub Id & Classif. 2015). The RMC can comprise molybdenum trioxide, molybdenum dioxide or any other oxide of molybdenum. On average, the compositions of RMC used as input material in the Examples and tests according to the present invention comprise impurities in the following concentrations: potassium 0.1292% by weight-, copper 0.45% by weight, arsenic 0.0052% by weight, phosphorus 0.0079% by weight, based on the total weight of RMC. In accordance with the present invention, the concentration of copper in the RMC can also be up to 4% by weight, preferably up to 2% by weight, based on the total weight of RMC.

In the examples according to the present invention, the pH and the temperature of the suspensions formed in the present invention were measured according to standard methodologies and with standard instrumentations.

When in at least one embodiment according to the present invention reference is made to the term “a first pH value”, reference may be made to a pH value of the first treated suspension which may be considered as a natural pH value of the first treated suspension, wherein reference is made to the pH value of a suspension being achieved solely adding a solid to be suspended, for example RMC, to a water-solution or an aqueous solution. Referring to particular embodiment according to the current invention, this first or natural pH value is at least 2.1, preferable between 2.1 and 2.8.

According to an embodiment of the present invention, this first or natural pH value is between 2.1 and 5.0, preferably between 2.1 and 4.0, preferably between 2.1 and 3.0, preferably between 2.1 and 2.8.

When in at least one embodiment according to an aspect of the invention reference is made to “reducing impurities from an RMC”, reference is made to reducing a concentration of impurities from an RMC.

When in at least one embodiment according to the present invention reference is made to the term “leach efficiency”, reference is made to the ratio between the final weight of the impurities leached out from the initial RMC according to the present invention and the initial weight of the impurities in the initial RMC, which ratio in weight expressed as a percentage.

When in at least one embodiment according to the present invention reference is made to the term “RMC cake”, reference is made to the purified RMC in solid form obtained after separation from the first treated suspension by separation means.

When in at least one embodiment according to the present invention reference is made to the term “slurry” or “suspension”, reference is made to a mixture of solids at least partially suspended in a liquid. In the context of the present invention, due to the insolubility of the molybdenum oxide in water, which is the main component in RMC, the first treated suspension and the second treated suspensions are water-based suspensions whereto impurities and molybdenum oxide are suspended to form a slurry. Therefore, it is intended to be clear for the skilled in the art, that with the term “slurry” or “suspension”, reference can be made to either the first or the second treated suspension.

When in at least one embodiment according to the present invention reference is made to the term “leaching”, reference is made to the process of extracting impurities from roasted molybdenum concentrate by dissolving them in a liquid.

When in at least one embodiment according to the present invention reference is made to the term “impurities”, reference is made to undesired compounds that solubilize in water and/or ammonia, such as, and not limited to, compounds of potassium, iron, phosphorus, arsenic and copper.

Where in embodiments according to the present invention reference is made to “liquid-to-solid (L/S) ratio”, reference may be made to the ratio in mass between the liquid and the solid material added to the liquid.

The present invention provides for reducing the concentration of impurities from a roasted molybdenum concentrate (RMC) to produce RMC consisting in greater part of molybdenum oxide, wherein the method comprises the following steps: a first treatment step, a second treatment step and a separation step. Specifically, the first treatment step comprises performing in a first reactor or a first series of reactors on at least a portion of the RMC during a first treatment reaction time to form a first treated suspension, the first treatment comprises a step of adding the at least a portion of the RMC to a water-solution or an aqueous solution, wherein the first treated suspension has a temperature from 10° C. to 100° C. In the first treated suspension, particles of molybdenum oxide, and other components, are suspended as they are essentially insoluble water. Due to the presence of a large majority of molybdenum oxide, a slurry is obtained after the water or an aqueous solution is added to the RMC, with insoluble particles of molybdenum oxide, and others, suspended into the first treated suspension. Generally, the potassium level in the roasted molybdenum concentrate prior the first treatment step is on average approximately 1600 weight-ppm and the level of copper is on average approximately 0.45% by weight, compared to the total weight of RMC, nevertheless, the method according to the present invention reduces the concentration of impurities in RMC even for higher concentrations of such impurities. The first treatment step is done preferably under vigorous agitation, with the purpose of leaching out the majority of the potassium. After the first treatment, the roasted molybdenum concentrate in contact with water will likely result in a slurry having a first pH value of at least 2.1 and preferably to at most 5.0, preferably to at most 4.0, preferably to at most 3.0; preferably a pH value between 2.1 and 2.8. In the circumstance in which the presence of impurities lowers the first pH value of the slurry below 2.1, the first pH value of the slurry is preferably increased so to be at least 2.1. Leaching with water also allows to leach out part of the impurities of copper, iron, arsenic and phosphorus. The suspension comprising RMC and water is kept under agitation at a temperature of at least 60° C., preferably at least 75° C. Nevertheless, the first treated suspension can have a temperature from 10° C. to 100° C., with a higher or lower temperature affecting the total reaction time required to leach out the potassium. The removal of impurities of potassium might be difficult to achieve during further processing, such as after the conversion to ammonium molybdenum salt, and therefore, it is important to remove most of the potassium prior such treatment. After the first treatment step, a second treatment step takes place. The first treated suspension can be transferred to the subsequent reactor if more than one reactor is present. The second treatment step comprises performing a second treatment in a second reactor or a second series of reactors on at least a portion of the first treated suspension during a second treatment reaction time, wherein the second treatment comprises a step of adding the at least a portion of the first treated suspension to an acid solution to form the second treated suspension, wherein the at least a portion of the first treated suspension has a temperature less than 70° C., and wherein the second treated suspension has a second pH value between 1.5 and 2.3. In a specific embodiment of the present invention, the second treated suspension has a second pH value between 1.8 and 2.0, and at temperature preferably less than 55° C. Surprisingly, it was found that if the acid solution is added to the slurry to form a second treated suspension, wherein the second treated suspension has a temperature of less than 70° C. and a second pH value between about 1.5 and 2.3, less potassium precipitates from the solution, and therefore an higher concentration of potassium can be leached out from the RMC. The inventors believe that presumably, at temperatures above 70° C. and for a second pH value lower than 1.5, jarosite KFe₃(OH)₆(50₄)₂ precipitates. Moreover, at a second pH value higher than 2.3, the leach efficiency of other impurities, especially copper, decreases. The slurry comprising RMC, water and the acid is kept under agitation, and its pH and temperature monitored, until the desired leach efficiency is reached. Then, the method according to the present invention comprises subsequently separating at least a portion of the second treated suspension after the second treatment reaction time. Suitable separation means can be, but not limited to, filtration and decantation. After separation, the RMC separated from impurities is recovered.

According to an embodiment of the present invention, prior to the step of adding the at least a portion of the first treated suspension to an acid solution to form the second treated suspension, a predetermined amount of water is added to the first reactor, the first series the second reactor or the second series of reactors such that the at least a portion of the first treated suspension has a temperature less than 70° C. The addition of a predetermined amount of water allows to lower the temperature without the need for more energy intensive methods of cooling or having to wait for the temperature of the first treated suspension to decrease by natural convection. The amount of water can be calculated by formulae in the state of the art.

According to an embodiment of the present invention, the composition of the at least one portion of the of the first treated suspension, is the same composition of the first treated suspension. Hence, in this embodiment, taking “at least a portion of the first treated suspension” means taking a certain weight or volume part of the suspension but not otherwise altering its composition.

According to an embodiment of the present invention, the at least one portion of the first treated suspension, is a suspension, preferably with the same composition as the first treated suspension.

According to an embodiment of the present invention, of the at least one portion of the of the first treated suspension, has the same or an increase solid content compared to the first treated suspension.

According to an embodiment of the present invention, for reducing the concentration of water-solution or an aqueous soluble impurities from RMC is better carried out with a total reaction time which is longer than 2 hours, preferably longer than 2.5 hours. The total reaction time is the sum of the first treatment reaction time and the second treatment reaction time, and therefore does not include the filtration time. An advantage of a total reaction time longer than 2 hours, is that copper and iron can be better removed. Hydrochloric acid can be utilized in the context of the present invention instead of sulphuric acid or aqueous solutions of sulphuric acid, or combinations thereof, but the use of sulphuric acid or solutions of sulphuric acid is preferred. When hydrochloric acid is used, the choice of higher grade materials is necessary for the construction of the reactors. In addition the use of hydrochloric acid is characterised by providing a lower leach efficiency.

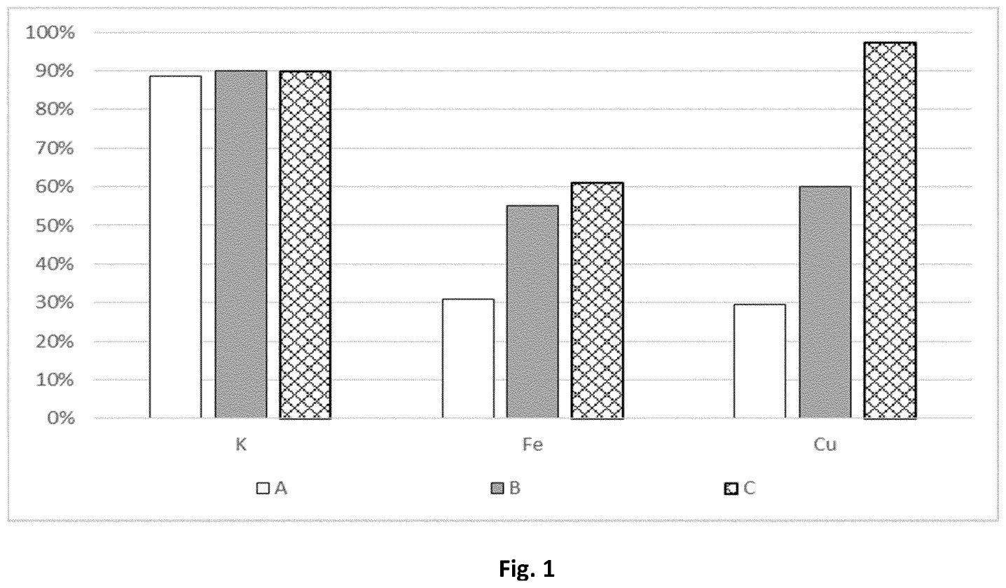

FIG. 1 illustrates a bar chart for the efficiency of leaching of impurities of potassium, iron and copper according to the present invention. In FIG. 1, the leach efficiency is expressed as a percentage along the Y-axis. Rectangular bars for each impurity analysed, with a height proportional to the leach efficiency for that specific impurity, is distributed along the X-axis. The leach efficiency for impurities of potassium, iron and copper is shown with respect to three different examples: A, B and C. Examples A, B and C have been carried out according to a batch process.

### BATCH EXPERIMENTS

### Example A

400 g of RMC is put into 1050 ml of water to form a slurry. Initially the temperature of the slurry is set to approximately 75° C. and is kept for the entire reaction time, which is 2.5 hours. After 2.5 hours, the cake is filtered and washed on the filter with 1050 ml of water. As it can be seen in FIG. 1, the majority of the impurities of potassium are leached out, but in contrast, the impurities of iron and copper are poorly leached out.

### Example B

400 g of RMC is put into 1050 ml of water to form a slurry. At the start, temperature is set to 75° C. and does not change for the entire reaction time, and also from the start, a solution of hydrochloric acid is added to the slurry, so that the slurry has a pH of approximately 1.9. Hydrochloric acid at different concentrations can be used. The reaction time is 2.5 hours. After 2.5 hours, the cake is filtered and washed on the filter with 1050 ml of water. As it can be seen in FIG. 1, the majority of the impurities of potassium are leached out, in contrast to example A, in example B the impurities of iron and copper are better leached out.

### Example C

400 g of RMC is put into 1050 ml of water to form a slurry, and therefore the liquid-to-solid ratio in mass (L/S) is 2.6:1. The addition of RMC to the water naturally causes the first pH value of the slurry formed to set at approximately 2.3. The total reaction time is 2.5 hours. At the start, temperature is set to approximately 75° C. After 40% of total reaction time, and therefore after 1 hour, the temperature is lowered to approximately 55° C. Once the lower temperature is reached, a solution of sulphuric acid is added and the first pH value is lowered to the second pH value of approximately 1.9, and the reaction is left under agitation for 1 hour and a half (1.5 hours). Sulphuric acid at different concentrations can be used. There is no filtration in between these leaching with water and after the addition of sulphuric acid. Therefore, in accordance with the present invention the first treatment reaction time is equal to 1 hour, whereas the second treatment reaction time is 1 hour and a half (1.5 hours). At the end of the total reaction time, the RMC cake is filtered and washed on the filter with 1050 ml of water. As it can be seen in FIG. 1, higher leaching efficiencies for potassium, iron and copper can be achieved. With respect to Example B, in Example C, copper is better dissolved by the sulphuric acid.

The leach efficiency results for the Examples A, B and C are shown in the table here below:

| | Leach efficiency | | |
|---|---|---|---|
| | K | Cu | Fe |
| Example A | | | |
| (Water leach only) | 89% | 30% | 31% |
| Example B | | | |
| (Acid leach with HCl) | 90% | 60% | 55% |
| Example C | | | |
| (Water leach | 90% | 97% | 61% |
| and Acid leach | | | |
| with H₂SO₄) | | | |

As it is evident from the table above, the method according to the present invention allows to obtain high leach efficiency with respect to both the impurities of potassium (leach efficiency 90%), and copper (leach efficiency 97%).

### Continuous Flow Experiments

The table here below shows the leach efficiency of impurities with respect to Examples D1, D2, and D3. For Examples D1, D2 and D3, the same RMC input is used, which input RMC has the following concentration of impurities:

Input (RMC)

| K | Cu | Fe | As | P |
|---|---|---|---|---|
| [wt %]* | [wt %]* | [wt %]* | [wt %]* | [wt %]* |
| 0.1746 | 0.52 | 1.39 | 0.0062 | 0.0071 |

*the weight percent [wt %] are based on the total weight of RMC

In accordance with the present invention, the concentration of impurities in RMC can be reduced via a continuous flow, in which multiple reactors are placed one after the other and the RMC sludge is continuously added to the first reactor and the mixture moves from one reactor to the next by overflow, and in which there might be a continuous output of at least a portion of the treated suspension.

Examples D1, D2, D3 relate to a continuous flow process. The average reaction time for Examples D1, D2 and D3 is 2.5 hours. The temperature of the slurry is set to approximately 75° C. and is kept for the entire reaction time.

### Example D1

The leaching is performed by performing a continuous process during which 400 g of RMC are added per 1050 ml of water. Leaching takes place using only water, a water-solution or an aqueous solution.

### Example D2

The leaching is performed with the same parameters as in example D1, but sulphuric acid is used is used instead of water. The pH value was set to 1.9.

### Example D3

In a first reactor of a series of reactors 400 g of RMC are added per 400 ml of water, which water has a temperature of 75° C. Via overflow, at least a portion of the first treated suspension is transferred to a second reactor of the series of reactors comprising a water-solution or an aqueous solution having the same temperature as the water in the first reactor. Thereafter, the material is transferred via overflow to a series of three reactors comprising an acid solution (H₂SO₄) having a pH value of 1.9 and a temperature of 55° C.

The leach efficiency results for the Examples D1, D2 and D3 are shown in the table here below:

Leach efficiency

| | K | Cu | Fe | As | P |
|---|---|---|---|---|---|
| | [%] | [%] | [%] | [%] | [%] |
| Example D1 | | | | | |
| (Water leach only) | 97% | 56% | 28% | 53% | 58% |
| Example D2 | | | | | |
| (Acid leach | 37% | 99% | 85% | 86% | 91% |
| with H₂SO₄) | | | | | |
| Example D3 | | | | | |
| (Water leach | 96% | 96% | 72% | 81% | 83% |
| and Acid leach | | | | | |
| with H₂SO₄) | | | | | |

The concentration of impurities in the purified RMC for the Examples D1, D2 and D3 is shown in the table here below:

| | Concentration of impurities in the purified RMC | | | | |
|---|---|---|---|---|---|
| | K | Cu | Fe | As | P |
| | [wt %]* | [wt %]* | [wt %]* | [wt %]* | [wt %]* |
| Example D1 | | | | | |
| (Water leach only) | 0.0140 | 0.30 | 1.23 | 0.0039 | 0.0031 |
| Example D2 | | | | | |
| (Acid leach | 0.1181 | 0.01 | 0.31 | 0.0012 | 0.0004 |
| with H₂SO₄) | | | | | |
| Example D3 | | | | | |
| (Water leach | 0.0148 | 0.07 | 0.56 | 0.0020 | 0.0001 |
| and Acid leach | | | | | |
| with H₂SO₄) | | | | | |

*the weight percent [wt %] are based on the total weight of RMC

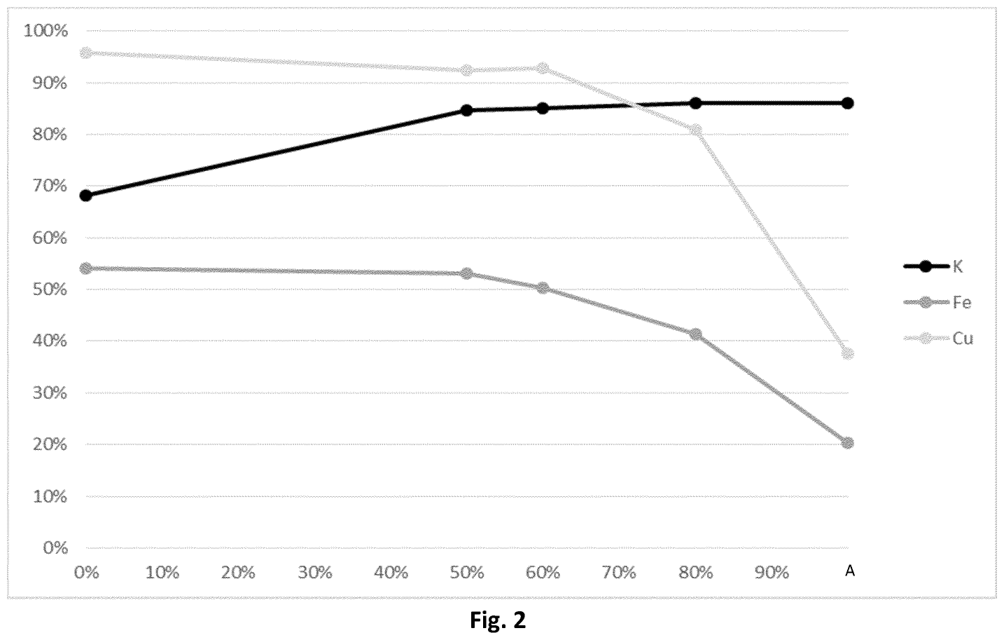

FIG. 2 illustrates the leach efficiency of impurities, shown on the Y-axis, with respect to the time of addition of sulphuric acid to the slurry, which time is expressed as percentage of the total reaction time, which is shown on the X-axis. The total reaction time is 2.5 hours. The test at “0%” means only the leaching with the acid is performed, from the start of the reaction (see Example E). In FIG. 2, also the results of Example A, for which no acid was added, are shown.

### Example E

400 g of RMC is put into 1050 ml of water, and the temperature is set at 75° C. and not changed. From the start, the pH of the suspension is adjusted to 1.9 with sulphuric acid. Reaction time is 2.5 hours. After 2.5 hours, the cake is filtered and washed on the filter with 1050 ml of water.

If before the adding a solution comprising sulphuric acid, the RMC is firstly contacted with water and then contacted with the solution of sulphuric acid according to the method of purification of the present invention, the leach efficiency for potassium increases, while the leach efficiency of copper and iron slightly decreases. It has been found that if the first treatment reaction time is between approximately 35% to 60%, preferably approximately 40% of the total reaction time, the leaching of potassium can be improved without decreasing the leach efficiency of copper and iron considerably.

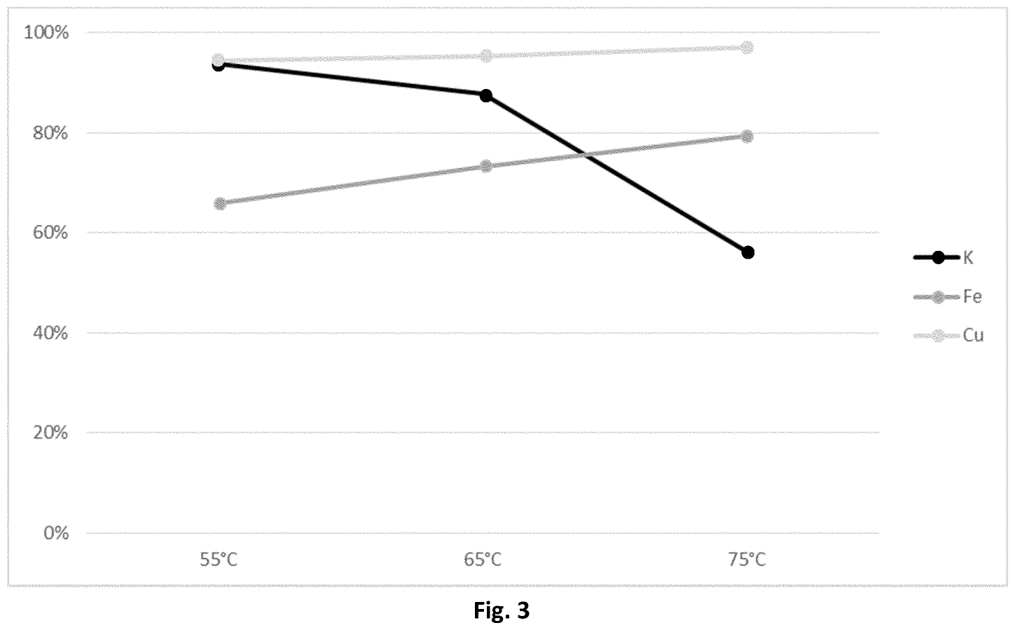

FIG. 3 illustrates the changes in leach efficiency of impurities with respect to the temperature of the slurry after addition of a solution comprising sulphuric acid. FIG. 3 illustrates the leach efficiency results obtained in accordance with Examples F1, F2, F3. The leach efficiency for the Examples F1, F2 and F3 is shown in the table here below:

| | Leach efficiency | | |
|---|---|---|---|
| | K | Fe | Cu |
| | [%] | [%] | [%] |
| Example F1 | | | |
| (Temperature of 55° C.) | 94 | 66 | 94 |
| Example F2 | | | |
| (Temperature of 65° C.) | 88 | 73 | 95 |
| Example F3 | | | |
| (Temperature of 75° C.) | 56 | 79 | 97 |

### Example F1

400 g of RMC is put into 1050 ml of water to form a slurry. At the start of the reaction, the temperature is set to 75° C. After 40% (1 hour) of the total reaction time (2.5 hours), the temperature is lowered to 55° C. and pH is lowered to 1.9 once the lower temperature is reached (using sulphuric acid). At the end of the reaction time the cake is filtered and washed on the filter with 1050 ml of water.

### Example F2

Example F2 differs from Example F1 in that after 40% of the total reaction time, the temperature is decreased to 65° C. before the pH is adjusted to 1.9 by adding sulphuric acid.

### Example F3

Example F3 differs from F1 and F2 in that after 40% of the total reaction time, the temperature is not decreased, but rather kept constant at 75° C.

In FIG. 3 it can be seen that the leach efficiency of potassium decreases when the temperature of the slurry increases after the addition of the sulphuric acid. Surprisingly, it was found that if the solution comprising sulphuric acid is added at a temperature lower than 70° C., preferably lower than 55° C., the removal of K by leaching is more efficient. It is believed that at temperatures above 70° C., and for a pH 1.5, jarosite (KFe₃(OH)₆(SO₄)₂) substantially precipitates. The precipitation of potassium and the loss of leach efficiency starts already at a temperature equals to or above 55° C., and for a pH less than or equal to about 1.8.

The method of purification according to the present invention can be advantageously performed as a continuous process. The present invention also relates to a leaching apparatus to perform the method of purification of roasted molybdenum concentrate according to other embodiments of the present invention, which apparatus comprises a first and a second series of reactors. A slurry is continuously added to the first leaching vessel, and the slurry is transferred from one reactor to the subsequent by overflow. A part of the first treated suspension may be removed, preferably through overflow, from the first series of reactors and received by a subsequent reactor, wherein the subsequent reactor may be a reactor from the first series of reactors or the second series of reactors.

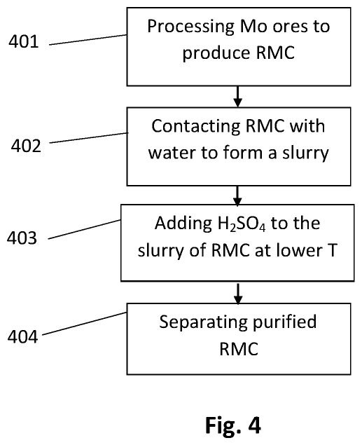

FIG. 4 illustrates steps of the method of purification of RMC in accordance with the present invention. The process to obtain purified RMC according to the present invention comprises the steps of processing molybdenum ores to produce RMC 401, contacting 402 RMC with water at higher temperature to form a slurry and having a first removal of impurities, mainly but not limited to, K, adding 403 the acid solution to the slurry of RMC at low temperature, and separating 404 the purified RMC.

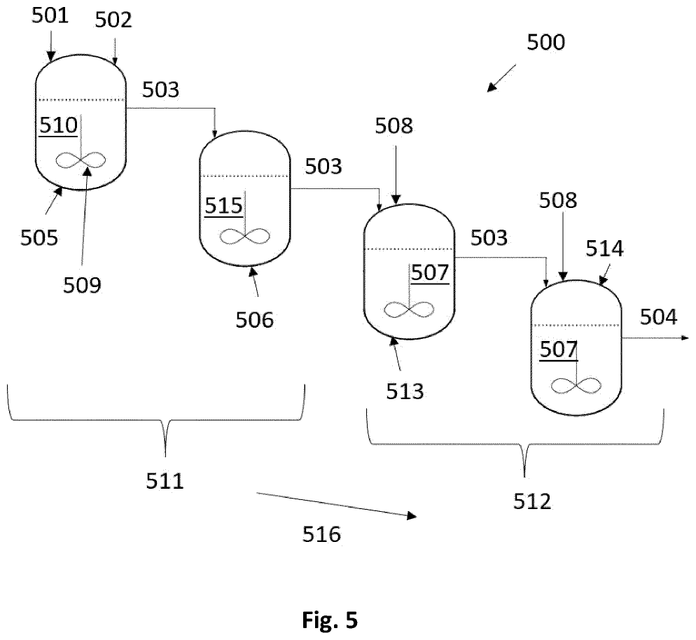

FIG. 5 illustrates an example of RMC treatment arrangement 500 adapted to perform the method according to the present invention. Different RMC treatment arrangements 500 can be designed and are suitable to carry out the method according to the present invention, such as by varying the number of reactors which can vary from one to as many as required to obtain the leaching efficiency desired. In accordance with the present invention, the concentration of impurities in RMC can be reduced via a continuous flow process, as demonstrated in FIG. 5, or a batch process.

When reference is made to an embodiment in which the first series of reactors and the second series of reactors are the same, reference is made to a batch process.

When reference is made to an embodiment in which the reactor in step a) and the reactor in step b are the same, reference is made to a batch process.

FIG. 5 illustrates a RMC treatment arrangement 500 comprising a first series 511 of one or more reactors 505 adapted for performing a first treatment on at least a portion of the RMC during a first treatment reaction time to form a first treated suspension 510, and a second series 512 of one or more reactors 506 adapted for performing a second treatment in a second series of one or more reactors on at least a portion of the first treated suspension during a second treatment reaction time.

According to the embodiment depicted in FIG. 5, the first series 511 and the second series 512 comprise each two reactors, i.e. the first series 511 comprises a first 505 and a second reactor 506, the second series 512 comprises a third 513 and a fourth 514 reactor. In a continuous process according to the present invention the reactors 505, 506, 513, 514 are placed subsequent to each other allowing either a further first treatment, e.g. transfer of material from the first reactor 505 to the second reactor 506, a second treatment, e.g. transfer of material from the second reactor to the third reactor 513, or a further second treatment, e.g. transfer of material from the third reactor 513 to the fourth reactor 514. The number of reactors is not limited to the amount as depicted in FIG. 5.

According to a preferred embodiment of the invention, the first series 511 of one or more reactors may consist of two reactors and the second series 512 of one or more reactors may consist of three reactors. This embodiment allows a method for reducing (a concentration of) impurities from an RMC wherein the first treatment reaction time is 40% of the total reaction time, and the second treatment reaction time is 60% of the total reaction time.

An advantage of the preferred embodiment in which the first series 511 and the second series 512 of one or more reactors are not the same or different, i.e. a continuous process, is that more RMC material can be handled on a shorter timescale in comparison with a batch process configuration as starting RMC material 502 can be added to the first reactor 505 in a continuous way or on specific time intervals which may be shorter than the first treatment reaction time.

The transfer of at least a portion of the first treated suspension 510 from a reactor, e.g. the first reactor 505, to a subsequent reactor, e.g. the second reactor 506, or from at least a portion of the second treated suspension 507 can be performed by overflow, without being limited to this equipment. The advantage of transferring material by overflow is that the process may be considered to consume less energy in comparison with an arrangement in which the material is transferred from one reactor to a subsequent reactor using transferring means, e.g. pumps, which may be computer-controlled. According to a specific embodiment of the current invention, the transfer of at least a portion of the first treated suspension 510 or second treated suspension 507 from one reactor to a subsequent reactor may be performed, but is not restricted to, a combination of overflow means and other transferring means.

In a preferred embodiment of the arrangement 500 according to the present invention, an agitator 509 may be placed in the reactors 505, 506, 513, 514 to keep the first treated suspension 510 or second treated suspension 507 of RMC particles present.

In a specific arrangement 500 showed in FIG. 5, a predetermined amount of water 501 and RMC 502 can be added to the first reactor 505 of the first series 511 of one or more reactors to perform a first treatment and to form a first treated suspension 510. Then, at least a portion of the first treated suspension 510 is transferred to a subsequent reactor 506 by, for example, overflow 503 without being restricted to this type of transferring. From the subsequent reactor 506, at least a portion of the first treated solution 510 may be transferred to a subsequent reactor, e.g. a first reactor of the second series 512 of at least one or more reactors for the second treatment. Hence, the skilled person may understand that the reactors are placed in the flow direction of the suspension in order to perform first a first treatment and secondly a second treatment, without being restricted to embodiments wherein the first treatment may be performed in one or more reactors of the first series 511 of reactors before being transferred 503 to one or more reactors of the second series 512 of reactors. The second treatment may also be performed in one or more reactors of the second series 512 of reactors.

After a second treatment reaction time, at least a portion of the second treated solution 507 may be removed or separated 504 from a reactor 513, 514 of the second series of one or more reactors, preferably the last reactor 514.

According to a preferred embodiment of the invention, reactors 513, 514 of the second series 512 of one or more reactors may comprise an acid solution. In order to obtain the desired pH value between 1.5 and 2.3, preferably between 1.8 and 2.0, more preferably of 1.9, the second series 512 of one or more reactors are adapted 508 to receive an acid solution.

To one or more reactors in the arrangement, an acid solution is added 508. In the context of the present invention, and as illustrated in FIG. 5, it has to be intended that the first two reactors 505, 506 belong to the first series 511 of reactors, wherein a water-based leach may occur, whereas the last two reactors 513, 514 belong to the second series 512 of one or more reactors, wherein an acid-based leach may occur.

The process of overflow 503 is a natural process which does not require complex control equipment, leading to a cost-efficient process. The separation of at least a portion of a first treated solution or at least a portion of a second treated solution may be performed by filtration, or decantation or any other technique suitable to separate the suspended particles of purified RMC from the suspension 510, 507 in order to, for example, separate 504 at least a portion of the second treated suspension from the second series 512 of one or more reactors from the arrangement 500. This separated 504 at least a portion of the second treated suspension comprises purified RMC and can be referred to as a treated RMC product containing a concentration of less than 0.0864% by weight, preferably less than 0.0240% by weight of potassium, less than 0.24% by weight, preferably less than 0.08% by weight of copper, and more than 50.00% by weight, preferably more than 56.47% by weight, preferably more than 58.67% by weight of molybdenum, based on the total weight of treated RMC product.

In case the RMC treatment arrangement 500 needs to be smaller, in the RMC treatment arrangement 500 the first 511 and the second 512 series of one or more reactors are the same, and therefore a single reactor is present. In this circumstance, the RMC, the water and the acid solution may be added to the same reactor, and no subsequent reactors are present. An advantage of this specific embodiment is that the method according to the present invention can be carried out in a reduced amount of space. Moreover, an advantage of the present embodiment is that the method according to the present invention can be performed in a smaller scale.

The invention also relates to the use of a purified roasted molybdenum concentrate (RMC) for the production of pure ammonium molybdenum (ADM) salts and MoO₃, wherein the purified RMC is obtained by at least one preferred embodiment of the method according to the current invention.

1. A method for reducing impurities from a roasted molybdenum concentrate (RMC), the method comprising the steps:
a. performing a first treatment in a first reactor (505) or a first series (511) of reactors (505, 506), on at least a portion of the RMC during a first treatment reaction time to form a first treated suspension (510, 515), the first treatment comprises a step of adding the at least a portion of the RMC (501) to water or an aqueous solution, wherein the first treated suspension (510, 515) has a temperature from 10° C. to 100° C. and a first pH value of at least 2.1 to at most 5.0;
b. performing a second treatment in a second reactor (513) or a second series (512) of reactors (513, 514), on at least a portion of the first treated suspension during a second treatment reaction time, wherein the portion of the first treated suspension comprises RMC solids from the first treated suspension, wherein the second treatment comprises a step of adding the at least a portion of the first treated suspension (510, 515) to an acid solution to form the second treated suspension (507), wherein the at least a portion of the first treated suspension (510, 515) has a temperature less than 70° C., and wherein the second treated suspension (507) has a second pH value between 1.5 and the first pH value;
c. separating (504) at least a portion of the second treated suspension (507) from the second reactor (513) or the second series (512) of reactors (513, 514) after the second treatment reaction time.

2. The method according to claim 1, wherein the acid solution comprises either hydrochloric acid or sulphuric acid, or combinations thereof, preferably sulphuric acid.

3. The method according to claim 1 or claim 2, wherein the method comprises, prior to the step of adding the at least a portion of the first treated suspension (510, 515) to an acid solution to form the second treated suspension (507), a step of adding a predetermined amount of water to the first reactor (505) or the first series of reactors (511) or to the second reactor (513) or the second series of reactors (512), such that the at least a portion of the first treated suspension (510, 515) has a temperature less than 70° C.

4. The method according to any one of claims 1 to 3, wherein at step a. the first treated suspension (510, 515) has a temperature of at least 60° C., preferably at least 75° C.

5. The method according to any one of claims 1 to 4, wherein the first reactor and the second reactor are the same.

6. The method according to any one of claims 1 to 4, wherein the first series (511) of reactors (505, 506) and the second series (512) of reactors (507) are the same.

7. The method according to any one of claims 1 to 6, further comprising a step of filtering the at least a portion of the first treated suspension from the first treated suspension (510, 515) prior to performing the second treatment, wherein the at least a portion of the first treated suspension which is passed on to the second treatment is the RMC cake.

8. The method according to any one of claims 1 to 7, further comprising a step of transferring (503) the at least a portion of the first treated suspension from the first reactor (505) or the first series (511) of reactors to at least one subsequent reactor, wherein the at least one subsequent reactor is selected from the group of the first reactor (505) or first series of reactors (511) and the second reactor (513) or second series (512) of reactors.

9. The method according to claim 8, wherein the step of transferring (503) is performed through overflow, wherein the first reactor (505) or the first series (511) of reactors and the subsequent reactor are placed in the flow direction (516) of the at least a portion of the first (510, 515) and second (507) treated suspension.

10. The method according to any of claims 1 to 9, wherein the second treated suspension (507) has a temperature of less than 65° C., preferably less than 55° C.

11. The method according to any one of claims 1 to 10, wherein the first pH value of the first treated suspension (510, 515) is at least 2.1 to at most 4.0, preferably at least 2.1 to at most 3.0, preferably at least 2.1 to at most 2.8.

12. The method according to any one of claims 1 to 11, wherein the second pH value of the second treated suspension (507) is between 1.8 and 2.0, preferably 1.9.

13. The method according to any one of claims 1 to 12, wherein the first treatment reaction time is between 20% to 80%, preferably between 35% to 60%, more preferably 40% of a total reaction time, wherein the total reaction time being the sum of the first treatment reaction time and the second treatment reaction time.

14. The method according to any one of claims 1 to 13, wherein the second treated suspension (507) has a liquid-to-solid ratio (L/S) in mass between 2.0 and 3.0, preferably 2.6.

15. (canceled)

16. (canceled)
